(19) United States
(12) Patent Application Publication
(10) Pub. No.: US 2011/0007908 A1
(43) Pub. Date: Jan. 13, 2011

(54) Speaker Capacitive Sensor

(75) Inventors: Doug K Rosener, Santa Cruz, CA (US); Casey G. Peterson, Scotts Valley, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: PLANTRONICS, INC., Santa Cruz, CA (US)

(21) Appl. No.: 12/501,961

(22) Filed: Jul. 13, 2009

(51) Int. Cl. H04R 1/10

(52) U.S. Cl. 381/74

(57) ABSTRACT

Methods and apparatuses for capacitive sensing are disclosed. In one example, a speaker includes a diaphragm and an electrically conductive material. The speaker electrically conductive material is adapted to form an electrode to measure capacitance.

### BACKGROUND OF THE INVENTION

The ability to determine whether a headset is currently being worn (“donned”) or not worn (“doffed” or “undonned”) on the ear of a user is useful in a variety of contexts. For example, whether a user's headset is donned or doffed may indicate the user's ability or willingness to communicate, often referred to as user “presence”. User presence is increasingly important as the methods, devices, and networks by which people may communicate, at any given time or location, proliferate. The determination of whether a user's headset is donned or doffed is also useful in a variety of other contexts in addition to presence.

As a result, improved methods and apparatuses for determining whether a headset is currently being worn or not worn by a headset is user are needed.

### BRIEF DESCRIPTION OF THE DRAWINGS

The present invention will be readily understood by the following detailed description in conjunction with the accompanying drawings, wherein like reference numerals designate like structural elements.

FIGS. 1A and 1B illustrate a headset having a speaker sensor in one example form factor.

FIG. 2 illustrates a block diagram of the headset illustrated in FIGS. 1A and 1B.

FIGS. 3A-3C illustrate a top, side, and bottom view respectively of a speaker sensor in one example.

FIG. 4A illustrates a cross-sectional view of a speaker sensor in one example.

FIG. 4B illustrates a cross-sectional view of a speaker sensor in a further example.

FIG. 5 is a schematic illustration of a headset having a capacitive touch sensing system.

FIG. 6A is a block diagram illustrating an architecture of the system for capacitive touch sensing.

FIG. 6B illustrates an alternative architecture of the system for capacitive touch sensing.

FIG. 7 illustrates a headset having both a speaker sensor and an additional dedicated donned/doffed sensor.

FIG. 8 illustrates a block diagram of the headset illustrated in FIG. 7.

FIG. 9 is a flow diagram illustrating a process for identifying a donned state or doffed state utilizing a speaker sensor.

FIGS. 10A and 10B are a flow diagram illustrating a process for identifying a donned state or doffed state utilizing a speaker sensor and an additional dedicated donned/doffed sensor.

### DESCRIPTION OF SPECIFIC EMBODIMENTS

Methods and apparatuses for capacitive sensing are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

This invention relates to capacitive touch sense solutions in head worn devices. In the prior art, capacitive touch sense solutions to detect a headset worn state have used a dedicated electrode. A dedicated electrode requires extra space and often requires special flex circuits and assembly procedures for forming connections and routing of wires.

The inventors have recognized that while sensing proximity to the user face can be done in various places on a headset, one place that conclusively indicates it is being worn is the headset region that goes near the ear opening or into the ear. The speaker in most headsets is usually very close to the ear opening, the optimum region for sensing that the headset is worn.

In one example, the speaker is utilized as a capacitive touch sense electrode. Using the existing headset speaker instead of a dedicated electrode offers several advantages over the prior art. No extra physical space or design work need be done to accommodate the sensor, and minimal additional parts are required since the speaker performs the dual functions of audio transducer and proximity sensor electrode.

In one example method of manufacture, the only additional manufacturing/assembly step is to solder a wire to one of the crimp tabs on a metal speaker cover and then pass this onto the main headset circuit board for processing in a capacitive touch sensor processor. In some cases, for long wire runs a coaxial cable is used for the electrode signal to shield the conductor from the audio wire signals and vice-versa. Thus, the additional manufacturing/assembly steps are minor as there are already wires being soldered onto the speaker for audio. Furthermore, it is easy to retrofit this sensor into existing plastic designs, and only an enhanced circuit board is required to process the electrode signal.

In one example, a headset includes a speaker comprising a diaphragm and an electrically conductive material adapted to form an electrode, and a processor adapted to receive signals from the electrically conductive material to determine a measured capacitance using the electrically conductive material. In one example, the headset may also include a microphone.

In one example, a speaker includes a diaphragm, a voice coil coupled to the diaphragm, a yoke, and a cover. The yoke or the cover is an electrically conductive material and is adapted to form an electrode to measure capacitance. The speaker is operable as a combination speaker and sensor.

In one example, a method for determining a headset donned state or a headset doffed state includes receiving a signal from a headset speaker electrically conductive material, processing the signal to determine a measured capacitance, and processing the measured capacitance to determine a headset donned state or a headset doffed state.

In one example, a headset includes a first sensor adapted to output a first signal associated with whether the headset is in a donned state or a doffed state, a second sensor adapted to output a second signal associated with whether the headset is in a donned state or a doffed state, and a processor adapted to receive the first signal and the second signal to determine a headset donned state or a headset doffed state. In one example, the headset may include a microphone.

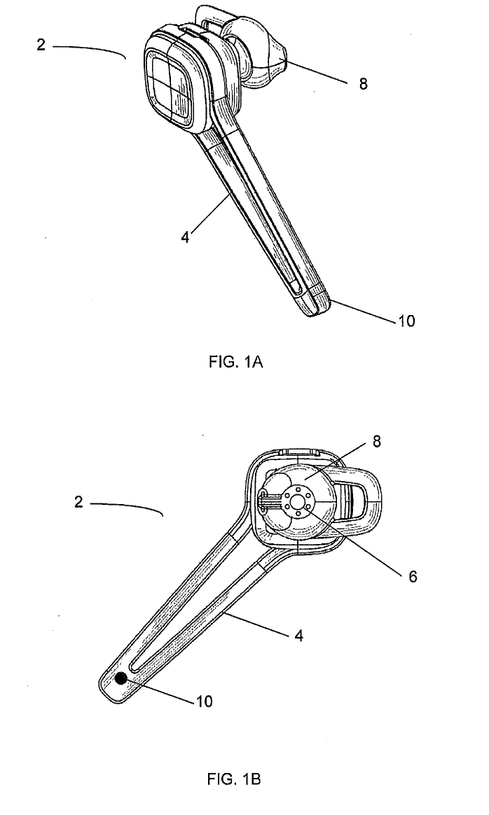

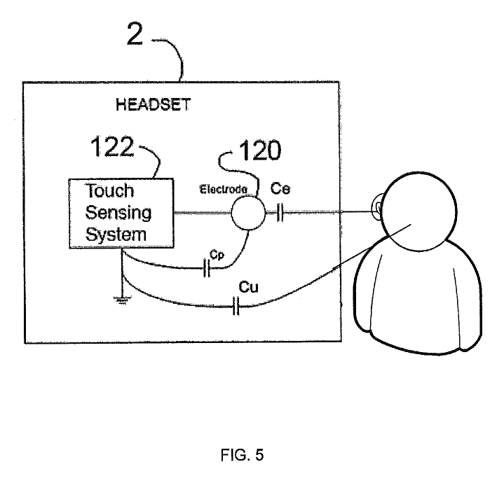

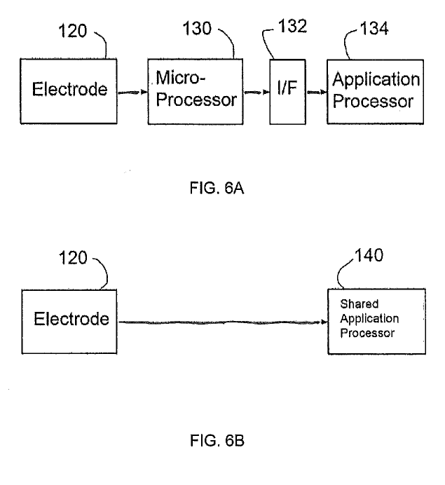

FIGS. 1A and 1B illustrate a headset 2 having a combination speaker sensor 6 in one example form factor, whereby the headset 2 has the capability to determine whether the headset 2 is doffed or donned. The headset 2 includes a body 4, a microphone 10, and an optional earpiece 8 covering a portion of the speaker sensor 6. Optional earpiece 8 may, for example, be composed of a soft flexible material such as rubber to conform to the user ear when headset 2 is donned. Some of the components of the headset 2 are conventional and will not be discussed in detail. The headset 2 includes a system which determines whether the speaker sensor 6 is touching or within close proximity or adjacent to the user ear, and an embodiment of the system is shown in FIG. 5 and FIGS. 6A-6B. FIG. 5 is a schematic illustration of a headset having a capacitive touch sensing system. FIG. 6A is a block diagram illustrating an architecture of the system for capacitive touch sensing. FIG. 6B illustrates an alternative architecture of the system for capacitive touch sensing.

In donning the headset 2, the user inserts the speaker sensor 6 into the concha of the ear, and speaker sensor 6 fits snugly in the concha so that the headset 2 is supported by the user's ear. The speaker sensor 6 is formed in part of electrically conductive material as described herein. The electrically conductive element of speaker sensor 6 can either contact the user's ear or be sufficiently close to the user's ear to permit detection of capacitance as discussed below. The speaker sensor 6 can be considered an electrode 120 in the circuit illustrated in FIG. 5 while the user's ear can be considered the opposing plate of a capacitor with the capacitance Ce. A touch sensing system 122 is electrically connected to the electrode 120, and the touch sensing system 122 determines whether the electrode 120 is touching or in close proximity to the user's ear based on the capacitance Ce when the electrode 120 is touching or close to the ear and when the electrode 120 is not. When electrode 120 is touching or in close proximity to the skin of the user's ear, an increase in relative capacitance is detected.

It should be understood that the touch sensing system 122 can be located on a printed circuit board (PCB), and there is parasitic capacitance between the electrode 120 and the PCB ground plane which is schematically illustrated as Cp. The capacitance between the user's ear and the electrode 120 is indicated as Ce, and Cu indicates the capacitance between the PCB ground plane and the user.

Thus, assuming that Cp is negligible or calibrated for, the total capacitance seen by the touch sensing system 122 is the series capacitance of the electrode to the ear, Ce, and the head to the system, Cu. The capacitive connection of the user to the system ground Cu is usually a factor of 10 or more than the capacitance of the ear to the electrode Ce, so that the Ce dominates. Means which can be used for determining the capacitance of the electrode 120 are known and will therefore not be discussed in detail herein. For example the single-slope method or the dual slope method can be used. The single slope method involves driving the electrode with a DC current source and measuring the time for the capacitance to reach a reference level. Use of capacitive touch sensing systems is also discussed in the commonly assigned and co-pending U.S. patent application Ser. No. 12/060,031 entitled “User Authentication System and Method” (Attorney Docket No.: 01-7437), which was filed on Mar. 31, 2008, and which is hereby incorporated into this disclosure in its entirety by reference.

In FIG. 6A there is a block diagram illustrating an architecture of a system for capacitive touch sensing. The system includes the electrode 120, a microprocessor 130 to receive signals from the electrode and which includes interface firmware and touch sensing firmware to acquire and analyze the measured capacitance of the electrode 120. The system also includes an interface 132 which can be in the form of hardware or software and an application processor 134. FIG. 6B illustrates an alternative architecture of the system for capacitive touch sensing which is included as part of a system providing other functions of a computer. In the architecture shown in FIG. 6B, system signals from the electrode 120 are transmitted to a shared application processor 140 which includes application firmware and touch sensing firmware to perform the necessary calculations.

In one example, the doffed or donned state of the headset is determined based on whether the speaker sensor 6 is touching or in close proximity to the user ear. If the speaker sensor 6 is touching the user's ear or in close proximity to the user's ear, the headset is determined to be donned whereas if the speaker sensor 6 is greater than a predetermined distance from the user's ear the headset is determined to be doffed.

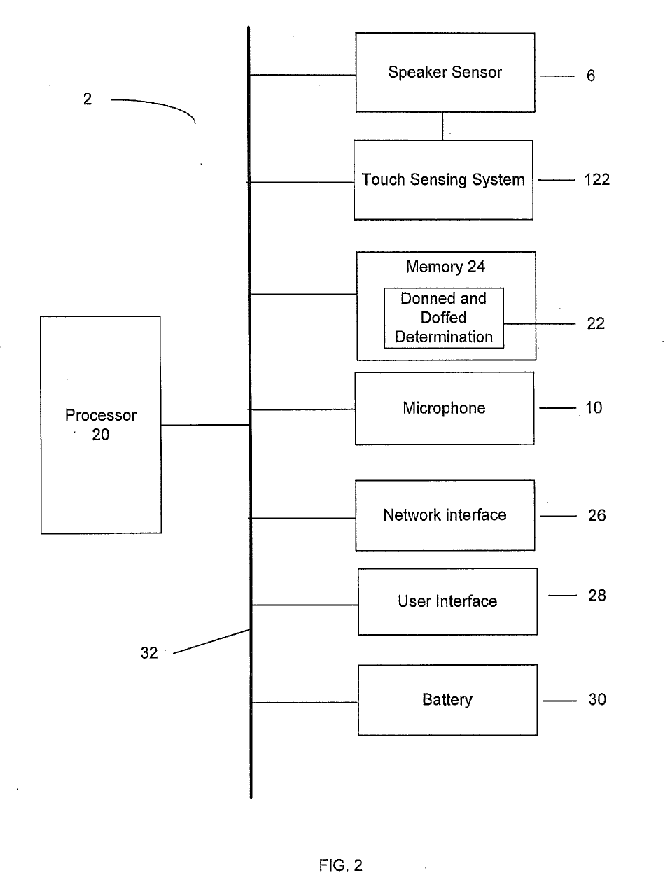

FIG. 2 illustrates a simplified block diagram of the headset 2 illustrated in FIGS. 1A and 1B. Headset 2 includes a processor 20 operably coupled via a bus 32 to a speaker sensor 6, a touch sensing system 122, a memory 24, a microphone 10, an optional network interface 26, battery 30, and a user interface 28. Speaker sensor 6 is coupled to the touch sensing system 122 so that touch sensing system 122 receives the output from speaker sensor 6.

Processor 20 controls the operation of the headset 2 and allows for processing data, in particular managing data between speaker sensor 6, touch sensing system 122, and memory 24 for determining the donned or doffed state of headset 2. In one example, processor 20 is a high performance, highly integrated, and highly flexible system-on-chip (SOC). Processor 20 may include a variety of separate or integrated processors (e.g., digital signal processors), with conventional CPUs being applicable, and controls the operation of the headset 2 by executing programs in memory.

Memory 24 may include a variety of memories, and in one example includes SDRAM, ROM, flash memory, or a combination thereof. Memory 24 may further include separate memory structures or a single integrated memory structure. In one example, memory 24 may be used to store passwords, network and telecommunications programs, and/or an operating system (OS). In one embodiment, memory 24 may store a donned and doffed determination module 22 which processes data from touch sensing system 122 to identify a headset donned state or headset doffed state. Memory 24 may also store signals or data from speaker sensor 6 for use by touch sensing system 122.

Speaker sensor 6 can utilize any type of electromagnetic, piezoelectric, or electrostatic type of driving element, or a combination thereof, or another form of driving element, for generating sound waves output from speaker sensor 6.

In one example, network interface 26 includes a transceiver for communicating with a wireless local area network (LAN) radio transceiver (e.g., wireless fidelity (WiFi), Bluetooth, ultra wideband (UWB) radio, etc.) for access to a network, or an adaptor for providing wired communications to a network. In one example, network interface 26 is adapted to derive a network address for the headset using the headset's electronic serial number, which is used to identify the headset on the network. In one embodiment, the electronic serial number may be the headset's Media Access Control (MAC) address; however, the electronic serial number may be any number that is mappable to a network address. Network interface 26 is adapted to communicate over the network using the network address that it derives for the headset. The network interface 26 may communicate using any of various protocols known in the art for wireless or wired connectivity.

User interface 28 allows for communication between the headset user and the headset, and in one example includes an audio and/or visual interface such that a prompt may be provided to the user's ear and/or an LED may be lit. For example, an audio interface may be initiated by the headset upon detection that the headset is donned. In addition, the audio interface can provide feedback to the user in the form of an audio prompt (e.g., a tone or voice) through the speaker sensor 6 indicating the headset is in place (i.e., “donned”).

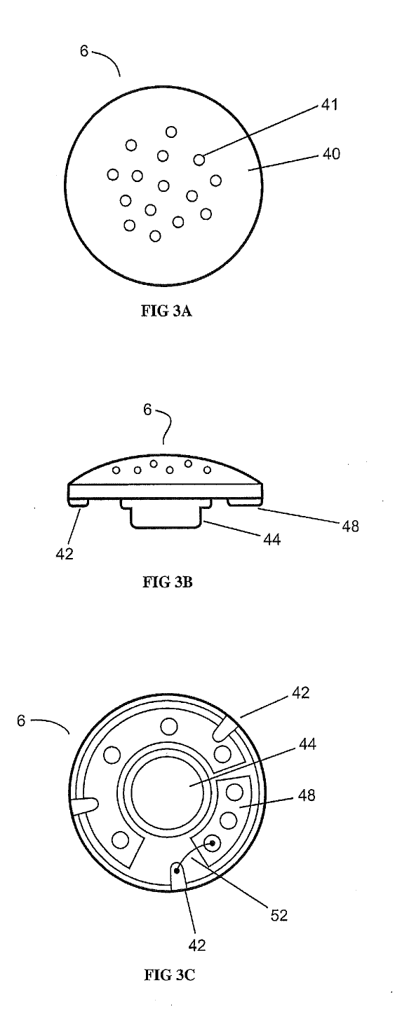

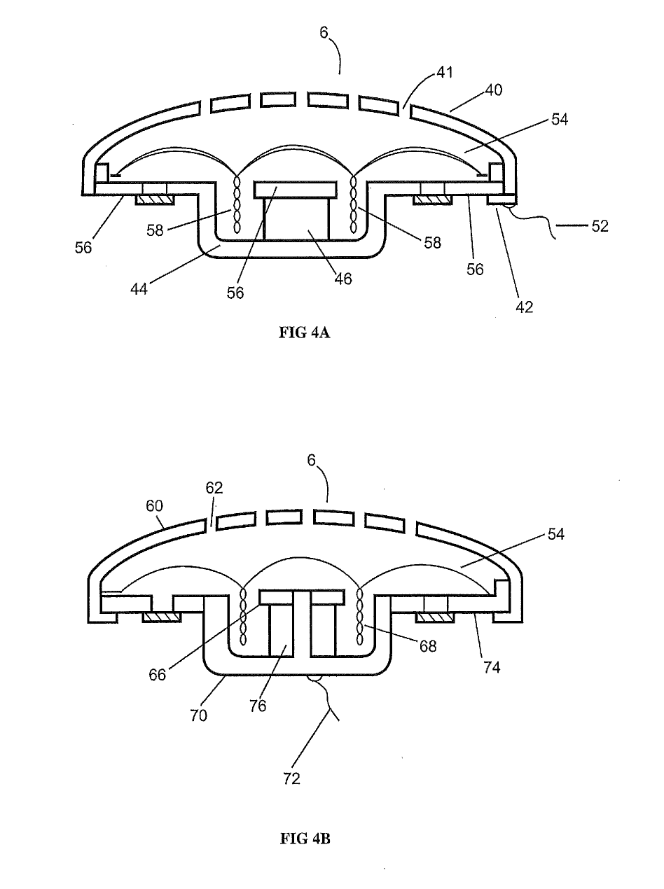

FIGS. 3A-3C illustrate a top, side, and bottom view respectively of a speaker sensor 6 in one example. FIG. 4A illustrates a cross-sectional view of a speaker sensor in one example. Referring to FIGS. 3A-3C and FIG. 4A, speaker sensor 6 includes a diaphragm 54, a voice coil 58 coupled to the diaphragm 54, a magnet 46, a frame 44, a cover 40 disposed over diaphragm 54, a pole piece 56 disposed over magnet 46 to complete a magnetic circuit, and an electrical lead 52. In this example configuration, magnet 46 serves as the speaker yoke. The frame and magnet together may also be referred to as the speaker yoke. Speaker sensor 6 further includes a printed circuit board (PCB) 48. Pole piece 56 is constructed of a magnetically permeable material.

In this example, the cover 40 is an electrically conductive material and is adapted to form an electrode to measure capacitance. For example, cover 40 is made of a copper material. In one example, the copper thickness is between 0.10 and 0.20 mm thick. However, one of ordinary skill in the art will recognize that other thicknesses may be utilized. The use of copper is particularly advantageous as soldering of the electrical lead to the copper material is highly effective to form a strong electrical coupling. In further examples, mechanical crimping of the electrical lead to the cover provides the necessary electrical coupling. In an example where the front cover is made of steel, a solderable material may be applied to the steel surface so that the electrical lead may be soldered to the cover.

Cover 40 includes a plurality of apertures 41 on its front surface through which sound waves generated by the diaphragm are output. While speaker sensor 6 is in operation, cover 40 faces the user's ear when the headset is worn. In one example, cover 40 includes a crimp tab 42 which mechanically crimps to the frame 44 which holds the magnet 46. In the example shown, the crimp tab 42 crimps to an outward face of a base portion of frame 44. In one example, the cover 40 is electrically coupled to the frame 44, but such electrical connection is not required. Cover 40 and frame 44 are electrically isolated from voice coil 58.

In one example, a first end of an electrical lead 52 is electrically connected via soldering to the crimp tab 42 and the second end of the electrical lead 52 is connected to the PCB 48. In this manner, the cover is utilized as an electrode to transmit a signal to PCB 48. The crimp tab 42 operates to mechanically affix the cover 40 to the remaining speaker assembly.

During audio operation of speaker sensor 6, a magnetic field generated by a magnetic circuit utilizing magnet 46 acts on voice coil 58. Audio signal current supplied to voice coil 58 causes the vibration of diaphragm 54, resulting in compression waves forward from the diaphragm through apertures 41 in cover 40 to produce sound.

FIG. 4B illustrates a cross-sectional view of a speaker sensor in a further example. As illustrated in FIG. 4B, speaker sensor 6 includes a diaphragm 64, a voice coil 68 coupled to the diaphragm 64, a donut shaped magnet 76, a yoke 70 holding magnet 76, a cover 60 which may be of non-conducting material having apertures 62, pole piece 66 disposed over magnet 76 to complete a magnetic circuit, a case/frame 74, and an electrical lead 72 coupled to the yoke 70. In this example, the yoke 70 is an electrically conductive material and is adapted to form an electrode to measure capacitance. For example, yoke 70 may be composed of cold rolled steel. The electrical lead 72 is connected between the yoke 70 and a PCB (not shown), whereby the yoke is utilized as the electrode in a touch sensing system.

In further examples, other metal materials in the speaker may be utilized as the electrode in alternative to the cover or yoke. For example, a speaker back cover, frame, basket, case or metal ring may be utilized in certain configurations. In a further example, pole pieces may be utilized as the electrode where the pole pieces are constructed of an electrically conductive material. In certain configurations, a speaker frame forms one of the pole pieces and is both electrically and magnetically conductive. When not used as a pole piece or transducer, the speaker frame can be plastic. In certain configurations, the yoke and frame are referred to synonymously. In one example, the frame and pole pieces are electrically and mechanically isolated from the voice coil. In further example, a variety of speaker configurations and constructions having various components composed of conductive metal materials suitable for use as an electrode may be employed. In certain examples, a conductive metal material may be plated with an additional conductor to accommodate a solder attachment to an electrical lead, or the electrical lead is mechanically crimped to the conductive metal material sufficient to form an electrical connection.

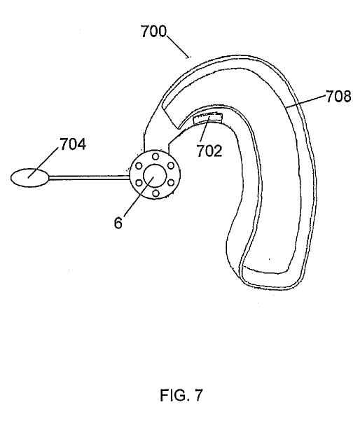

FIG. 7 illustrates a headset 700 having both a speaker donned/doffed sensor 6 and an additional dedicated donned/doffed sensor 702 disposed at a location within a headset housing 708 remote from the speaker sensor 6. For example, dedicated donned/doffed sensor 702 may be disposed somewhere along a spine of the headset housing 708. Speaker sensor 6 operates as described above to measure a capacitance associated with whether the headset is in a donned state or a doffed state. For example, speaker sensor 6 may utilize an electrically conductive cover adapted to form an electrode. Dedicated donned/doffed sensor 702 is adapted to output a signal associated with whether the headset is in a donned state or a doffed state.

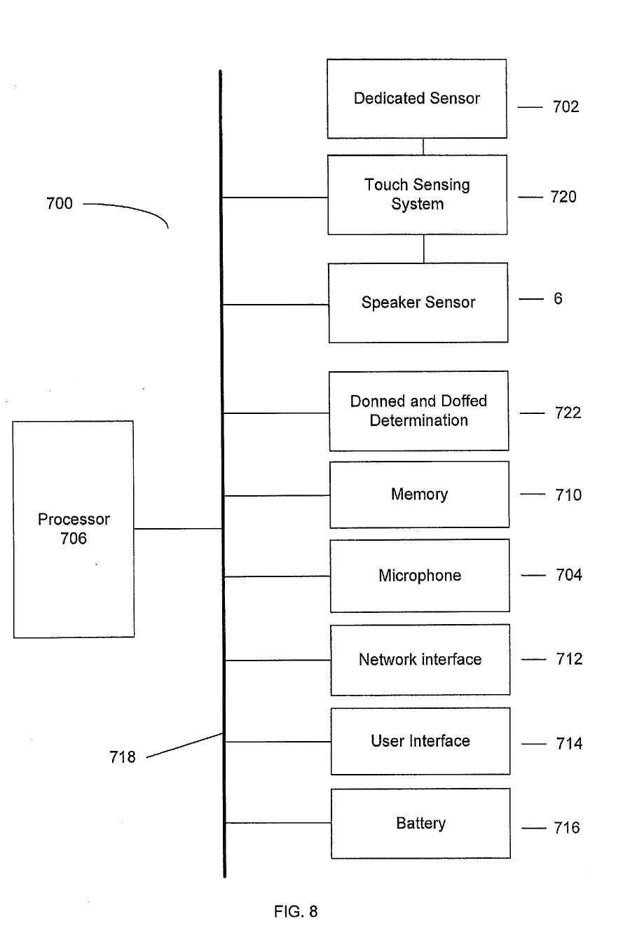

FIG. 8 illustrates a block diagram of the headset 700 illustrated in FIG. 7. Headset 700 includes a processor 706 operably coupled via a bus 718 to a dedicated sensor 702, speaker sensor 6, a touch sensing system 720, a donned and doffed determination module 722, a memory 710, a microphone 704, an optional network interface 712, a user interface 714, and a battery 716. Speaker sensor 6 and dedicated sensor 702 are coupled to the touch sensing system 122 so that touch sensing system 122 receives the output from speaker sensor 6 and dedicated sensor 702.

In one example, dedicated sensor 702 is a capacitive sensor. However, dedicated sensor 702 may be any type of sensor or detector capable of outputting a signal that may be utilized to determine whether the headset 700 is donned. For example, dedicated sensor 702 may measure kinetic energy, temperature, and/or capacitance. Some techniques that can be used to determine whether the headset is donned or undonned include, but are not limited to, utilizing one or more of the following sensors or detectors integrated in the headset 700: a thermal or infrared sensor, skin resistivity sensor, capacitive touch sensor, inductive proximity sensor, magnetic sensor, piezoelectric-based sensor, and motion detector. Further details regarding these sensors and detectors and methods can be found in the commonly assigned and co-pending U.S. patent application entitled “Donned and Doffed Headset State Detection” (Attorney Docket No.: 01-7308), which was filed on Oct. 2, 2006, and which is hereby incorporated into this disclosure by reference. In a further example, speaker sensor 6 is replaced with an alternative type of donned/doffed sensor that may or may not be a capacitive sensor.

Processor 706 allows for processing data, in particular managing data between dedicated sensor 702, speaker sensor 6, touch sensing system 720, donned and doffed determination module 722, and memory 710 for determining the donned or doffed state of headset 2. In one embodiment, memory 710 may store a donned and doffed determination module 722 which when executed by processor 706 processes data from both dedicated sensor 702 and touch sensing system 122 to identify a headset donned state or headset doffed state. Memory 710 may also store signals or data from dedicated sensor 702 and speaker sensor 6.

In one example, both dedicated sensor 702 and speaker sensor 6 must both output a signal which when processed indicates a donned state in order for donned and doffed determination module 722 to indicate that headset 700 is donned. In this manner, false reporting of a donned condition resulting from handling of the headset 700 is minimized. For example, should a user engage one of the sensors while picking headset 700 up, the headset 700 will not indicate a donned state.

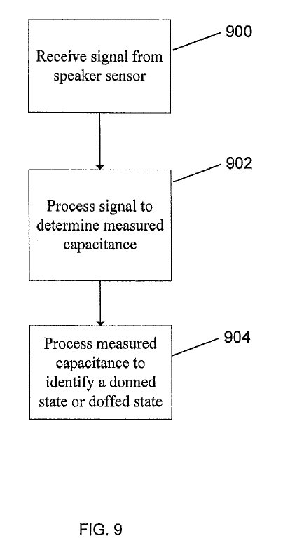

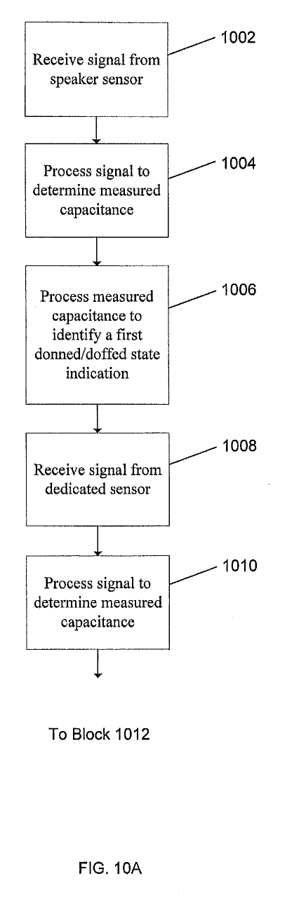

FIG. 9 is a flow diagram illustrating a process for identifying a donned state or doffed state utilizing a speaker sensor. At block 900, a signal is received from an electrically conductive material at a speaker sensor. At block 902, the signal is processed to determine a measured capacitance. At block 904, the measured capacitance is processed to determine a headset donned state or a headset doffed state.

In an example where a second, dedicated sensor is utilized in addition to the speaker donned/doffed sensor, the process may further include receiving an additional signal from the dedicated sensor and processing the additional signal together with the speaker sensor measured capacitance to determine a headset donned state or a headset doffed state. In one configuration, both the additional signal from the dedicated sensor and the speaker sensor measured capacitance must indicate a donned state to indicate a headset donned state. In an example where the dedicated sensor is a capacitive sensor, the additional signal is an additional measured capacitance that is processed together with the speaker sensor measured capacitance. In this manner, a single touch sensor processing system may be used to process both measured capacitances.

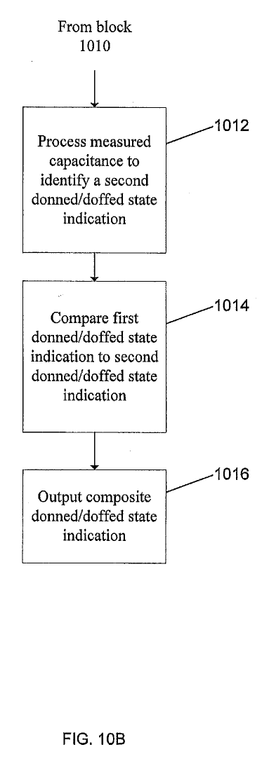

FIG. 10 is a flow diagram illustrating a process for identifying a donned state or doffed state utilizing a speaker sensor and an additional dedicated donned/doffed sensor. At block 1002, a signal is received from an electrically conductive material at a speaker sensor. At block 1004, the signal is processed to determine a measured capacitance. At block 1006, the measured capacitance is processed to identify a first donned/doffed state indication. At block 1008, a signal is received from a dedicated donned/doffed sensor. At block 1010, the signal is processed to determine a measured capacitance. At block 1012, the measured capacitance is processed to identify a second donned/doffed state indication. At block 1014, the first donned/doffed state indication and the second donned/doffed state indication are compared to determine a composite donned/doffed state indication. In one example, both the first donned/doffed state indication and the second donned/doffed state indication must both indicate a donned state in order for the composite donned/doffed state indication to indicate a donned state. At block 1016, a composite donned/doffed state indication is output.

While the exemplary embodiments of the present invention are described and illustrated herein, it will be appreciated that they are merely illustrative and that modifications can be made to these embodiments without departing from the spirit and scope of the invention. For example, the speaker sensor described herein may be embodied in other mobile devices in addition to headsets. Although certain examples describe telecommunications headsets having microphones, in further examples the speaker sensor described herein may be employed in listening headphones not having a microphone. Thus, the scope of the invention is intended to be defined only in terms of the following claims as may be amended, with each claim being expressly incorporated into this Description of Specific Embodiments as an embodiment of the invention.

What is claimed is:

1. A headset comprising:
a speaker comprising a diaphragm and an electrically conductive material adapted to form an electrode; and
a processor adapted to receive signals from the electrically conductive material to determine a measured capacitance using the electrically conductive material.

2. The headset of claim 1, wherein the processor is further adapted to process the measured capacitance to determine a headset donned state or a headset doffed state.

3. The headset of claim 1, wherein the electrically conductive material forms a speaker yoke or a speaker cover.

4. The headset of claim 1, wherein the electrically conductive material is copper and forms a speaker cover.

5. The headset of claim 1, wherein the electrically conductive material forms a speaker pole piece, back cover, ring, frame, basket, or case.

6. The headset of claim 1, further comprising a dedicated capacitive sensor to measure an additional measured capacitance, wherein the processor is further adapted to process both the measured capacitance and the additional measured capacitance to determine a headset donned state or a headset doffed state.

7. The headset of claim 6, wherein the headset further comprises a housing having a spine portion wherein the dedicated capacitive sensor is disposed.

8. The headset of claim 1, wherein the electrode is operable to measure a capacitance associated with whether the speaker is in proximity to a user skin.

9. A speaker comprising:
a diaphragm;
a voice coil coupled to the diaphragm;
a yoke; and
a cover, wherein the yoke or the cover comprise an electrically conductive material and is adapted to form an electrode to measure capacitance.

10. The speaker of claim 9, further comprising a printed circuit board to receive a signal from the yoke or the cover.

11. The speaker of claim 9, wherein the cover comprises a crimp tab crimpable to the yoke, the speaker further comprising an electrical lead connected to the crimp tab.

12. The speaker of claim 9, wherein the electrically conductive material is copper.

13. The speaker of claim 9, wherein the cover is a front cover comprising a plurality of apertures through which sound waves generated by the diaphragm are output.

14. A method for determining a headset donned state or a headset doffed state:
receiving a signal from a headset speaker electrically conductive material;
processing the signal to determine a measured capacitance; and
processing the measured capacitance to determine a headset donned state or a headset doffed state.

15. The method of claim 14, wherein the headset speaker electrically conductive material forms a speaker cover or yoke.

16. The method of claim 14, further comprising receiving an additional signal from a dedicated donned/doffed sensor and processing the additional signal together with the measured capacitance to determine a headset donned state or a headset doffed state.

17. A headset comprising:
a first sensor adapted to output a first signal associated with whether the headset is in a donned state or a doffed state;
a second sensor adapted to output a second signal associated with whether the headset is in a donned state or a doffed state; and
a processor adapted to receive the first signal and the second signal to determine a headset donned state or a headset doffed state.

18. The headset of claim 17, wherein the first sensor is a headset speaker adapted to measure a capacitance associated with whether the headset is in a donned state or a doffed state.

19. The headset of claim 18, wherein the second sensor is selected from the following group: thermal or infrared sensor, skin resistivity sensor, capacitive touch sensor, inductive proximity sensor, magnetic sensor, piezoelectric-based sensor, and motion detector.

20. The headset of claim 18, wherein the headset speaker comprises an electrically conductive cover adapted to form an electrode.

21. The headset of claim 18, wherein the processor is adapted to output an audio prompt through the headset speaker responsive to determination of a headset donned state.
